(19) United States
(12) Patent Application Publication
(10) Pub. No.: US 2008/0195662 A1
(43) Pub. Date: Aug. 14, 2008

(54) Automated display of selected press releases of legal institutions within websites

(76) Inventor: Norbert Gugerbauer, Wien (AT)

Correspondence Address: Norbert Gugerbauer, Opernring 1, Wien, A-1010, omitted

(21) Appl. No.: 11/705,589

(22) Filed: Feb. 13, 2007

(51) Int. Cl. G06F 17/30

(52) U.S. Cl. 707/104.1; 707/E17.008

(57) ABSTRACT

A method to compile, reconcile and display press releases of legal institutions according to the user's choice. By this method such press releases are read out, stored in a database and kept up-to-date; by signing up for this service the user will be provided with a specific source code on the service provider's website which is integrated into the user's website as IFRAME subsequently. The press releases show up as links in the IFRAME on the user's website, and by clicking on, they appear in full-text style.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

Not applicable.

### BACKGROUND OF THE INVENTION

Numerous institutions publish press releases regularly, and not few of them display them—additionally or exclusively—on their websites. In particular the press releases of legal institutions as courts, authorities and legislative bodies are of high importance for a wide range of persons (from lawyers, judges, lobbyists to business persons as well as random citizens) and quick and easy access to their content is of undoubted benefit to these groups. Today interested persons have to check several websites of their preferred institutions to see whether new information has been released—which proves to be a very time-consuming undertaking. Alternatively, interested persons can sign up for online newsletters and literally hope that the newsletter editor did his job prompt and well in arranging and selecting the suitable information for the users. In both cases direct access to the original and authentic press release is long winded or even uncertain.

### SUMMARY OF THE INVENTION

The “automated display of selected press releases of legal institutions within websites” avoids these uncertainties. It retrieves and compiles press releases of selected legal institutions. In doing so, the system keeps the press releases up-to-date by an automated regular data reconciliation process. Any interested person is provided for the opportunity to choose among these institutions on the service provider's website whereupon a specific source code will be announced on the screen by the system. This source code can be integrated into the user's website as a so-called “IFRAME” by copying and pasting it into the html-code of the user's website. When the user's website is subsequently retrieved in an internet browser, an automatic connection to a particular page of the service provider's website is established and a frame is displayed on the user's website in which links to the up-to-date press releases of the selected institutions emerge. By clicking on such a link the press release is displayed in the same frame in full-text style.

### DETAILED DESCRIPTION OF THE INVENTION

The uniform resource locaters (URLs) of websites of selected courts, authorities and legislative bodies (in the following referred to as “institutions”) on which links are regularly placed to those institutions' up-to-date press releases are to be stored in a service provider's database. By means of a standard computer software those URLs are retrieved continuously in short intervals, each press release displayed on the corresponding websites is read out and reconciled with the press releases which have already been stored in the service provider's database. If through this process a new (i.e. not already stored) press release is identified, the press release's title and full-text will be saved in the service provider's database.

Any interested person (in the following referred to as “user”) is able to register for the service provider's website in order to receive the automated display of press releases on a website that is maintained by the user. Therefore check boxes are provided on the service provider's website where the user can select particular predefined institutions—by checking a box the corresponding institution's press release will be shown on the user's website. It is possible to choose more than one box.

This is carried out as follows: The URL of the user's website has to be entered into an input box on the service provider's website and thereby a user-ID is created by the software application. This digital information together with the above mentioned selection of institution or institutions is stored in the service provider's database and a specific source code is generated based on the data provided by each single user. Subsequently, this source code is displayed on the service provider's website and can be integrated into the user's website as a so-called “IFRAME” by copying and pasting the source code into the html-code of the user's website.

When the user's website which contains the IFRAME is retrieved in an internet browser, an automatic connection to a particular page of the service provider's website is established. This particular page generates a specific data packet according to the user-ID (which is integrated into the IFRAME source code) and according to the user's preselection of institutions. This data packet emerges on the user's website as a frame in which links to up-to-date press releases of the selected institutions are displayed. Additionally, the press release is displayed in the same frame in full-text style by clicking on such a link.

What claimed is:

1. A method to compile, reconcile and display press releases of legal institutions, comprising:
(a) Selecting such legal institutions (courts, authorities and legislative bodies) which display press releases on their websites by the service provider;
(b) Displaying these selected institutions on the service provider's website;
(c) Storing of the uniform resource locators (URLs) of the selected institutions' websites in a database;
(d) Retrieving these URLs regularly in certain intervals;
(e) Reading out the press releases on the websites corresponding to these URLs;
(f) Storing title and full-text of these press releases in a database;
(g) Reconciling these press releases with the already stored press releases in a way that a not already stored press release is stored in addition;
(h) Providing an internet website (the service provider's website) which displays the selected institutions under (a) in connection with check boxes;
(i) Entering the URL of the user's website into an input box on the service provider's website;
(j) Checking one or more of the boxes under (h) by the user;
(k) Creating a user-ID by a standard software using the information provided under (i);
(l) Generating a specific source code based on the information provided under (i) and (j) together with the user-ID;
(m) Displaying this source code on the service provider's website;
(n) Copying and pasting this source code into the html-code of the user's website as an IFRAME;
(o) Establishing an automatic connection to a particular page of the service provider's website, when the user's website containing the IFRAME is retrieved in an internet browser;
(p) Connecting the user's selection provided under (j) with the corresponding institution's press release(s) according to (f) and (g);
(q) Generating a data packet according to the user-ID and the information under (p);
(r) Displaying this data packet in the shape of web links stating the title(s) of the press release(s) in a frame on the user's website;
(s) Displaying the full text of the press release(s) in the same frame by clicking on such a link.
